(19) United States
(12) Patent Application Publication
(10) Pub. No.: US 2019/0135448 A1
(43) Pub. Date: May 9, 2019

(54) SERVICE, VICINITY, AND VEHICLE INCIDENT MITIGATION

(71) Applicant: Eleytheria, LLC, Cleveland, OH (US)

(72) Inventors: David J. Akers, University Heights, OH (US); Gregory P. Temel, Shaker Heights, OH (US); Jason A. Korosec, Stamford, CT (US)

(21) Appl. No.: 16/242,387

(22) Filed: Jan. 8, 2019

Related U.S. Application Data
(63) Continuation-in-part of application No. 16/055,592, filed on Aug. 6, 2018.
Application No. 16/055,592 is a continuation of application No. 14/702,693, filed on May 2, 2015, now Pat. No. 10,040,573.
Application No. 14/702,693 is a continuation of application No. 11/106,871, filed on Apr. 15, 2005, now Pat. No. 9,038,962.
Application No. 11/106,871 is a continuation of application No. 10/245,064, filed on Sep. 17, 2002, now abandoned.
(60) Provisional application No. 60/322,867, filed on Sep. 17, 2001.

(51) Int. Cl. B64D 45/00; G08G 5/00; G08B 25/00

(52) U.S. Cl. CPC B64D 45/0015; G08G 5/0056; B64D 2045/0045; G08B 25/001; B64D 2045/0055; G08G 5/0013

(57) ABSTRACT

Architectures and techniques are presented that can mitigate danger presented by an unsafe condition that can affect a vehicle or an occupant of the vehicle. An unsafe condition can be identified based on activation input, which can be received from an incident activation device such as a panic button or a sensor that detects the unsafe condition. The activation input can trigger an incident mitigation procedure that can determine a safe destination for the vehicle or occupant and a safe course by which to navigate to the safe destination.

### CROSS-REFERENCE TO RELATED APPLICATIONS

This application is a continuation-in-part of, and claims priority to each of, U.S. patent application Ser. No. 16/055,592, filed Aug. 6, 2018, and entitled, “SYSTEM AND METHOD FOR AIRCRAFT INCIDENT MITIGATION,” which is a continuation of U.S. patent application Ser. No. 14/702,693 (now U.S. Pat. No. 10,040,573), filed May 2, 2015, and entitled, “SYSTEM AND METHOD FOR AIRCRAFT INCIDENT MITIGATION,” which is a continuation of U.S. patent application Ser. No. 11/106,871 (now U.S. Pat. No. 9,038,962), filed Apr. 15, 2005, and entitled, “SYSTEM AND METHOD FOR AIRCRAFT INCIDENT MITIGATION,” which is a continuation of U.S. patent application Ser. No. 10/245,064, filed Sep. 17, 2002, and entitled, “SYSTEM AND METHOD FOR AIRCRAFT INCIDENT MITIGATION,” which claims the benefit of U.S. Provisional Application Ser. No. 60/322,867, filed Sep. 17, 2001, and entitled, “SYSTEM AND METHOD FOR AIRCRAFT INCIDENT MITIGATION,” the entireties of which are incorporated herein by reference.

### TECHNICAL FIELD

The present invention relates to the field of incident mitigation, and more particularly to incident mitigation in the context of a consumer service, a vehicle, or vicinity such as the vicinity of the consumer service or the vehicle

### BACKGROUND OF THE INVENTION

In operational use of vehicles or vicinities or services thereof, unsafe conditions can arise, which can represent a threat to person or property.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later.

According to an embodiment of the present invention, an incident mitigation system can comprise a memory that stores computer executable components and a processor that executes computer executable components stored in the memory. The computer executable components can comprise a safety component that can receive activation input. In response to the activation input, the safety component can trigger an incident mitigation procedure determined to mitigate an unsafe condition for the vehicle that is in operational use. The computer executable components can comprise protocol component that can execute the incident mitigation procedure. For example, the incident mitigation procedure can comprise determining safety navigation data. The safety navigation data can be representative of a safe destination for the vehicle and a safe course for the vehicle. The safe destination can be a destination at which it is determined to be safe to terminate the operational use of the vehicle. The safe course can be a course determined to be safe by which to navigate the vehicle to the safe destination.

In some embodiments, elements described in connection with the system can be embodied in different forms such as a computer-implemented method, a computer-readable medium, or another form.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram of an aircraft incident mitigation system in accordance with one or more embodiments of the disclosed subject matter.

FIG. 2 is a schematic block diagram of an aircraft incident mitigation system in accordance with one or more embodiments of the disclosed subject matter.

FIG. 3 is a schematic block diagram of an aircraft incident mitigation system in accordance with one or more embodiments of the disclosed subject matter.

FIG. 4 is a schematic block diagram of a safe zone component in accordance with one or more embodiments of the disclosed subject matter.

FIG. 5 is a state diagram in accordance with one or more embodiments of the disclosed subject matter.

FIG. 5a is a state diagram in accordance with one or more embodiments of the disclosed subject matter.

FIG. 6 is a schematic block diagram of an aircraft incident mitigation system in accordance with one or more embodiments of the disclosed subject matter.

FIG. 7 is a schematic block diagram of an aircraft incident mitigation system in accordance with one or more embodiments of the disclosed subject matter.

FIG. 8 is a flow chart illustrating a methodology for mitigating an aircraft incident content in accordance with one or more embodiments of the disclosed subject matter.

FIG. 9 is a flow chart illustrating a methodology for mitigating an aircraft incident content in accordance with one or more embodiments of the disclosed subject matter.

FIG. 10 is a flow chart illustrating a methodology for mitigating an aircraft incident content in accordance with one or more embodiments of the disclosed subject matter.

FIG. 11 is a flow chart illustrating a methodology for mitigating an aircraft incident content in accordance with one or more embodiments of the disclosed subject matter.

FIG. 12 is a schematic block diagram of an incident mitigation system in accordance with one or more embodiments of the disclosed subject matter.

FIG. 13 is a schematic block diagram of a first example of additional aspects or elements of the incident mitigation system in accordance with one or more embodiments of the disclosed subject matter.

FIG. 14 is a schematic block diagram of a second example of additional aspects or elements of the incident mitigation system in accordance with one or more embodiments of the disclosed subject matter.

FIGS. 15A-C illustrate block diagrams of example architectural implementations that can be employed in accordance with one or more embodiments of the disclosed subject matter.

FIG. 16 illustrates a flow diagram of an example, non-limiting computer-implemented method that can mitigate an unsafe condition in accordance with one or more embodiments of the disclosed subject matter.

FIG. 17 illustrates a flow diagram of an example, non-limiting computer-implemented method that can provide for additional aspects or elements in connection with mitigating the unsafe condition in accordance with one or more embodiments of the disclosed subject matter.

FIG. 18 illustrates a block diagram of an example, non-limiting operating environment in which one or more embodiments described herein can be facilitated.

FIG. 19 illustrates a schematic block diagram of an exemplary computing environment.

### DETAILED DESCRIPTION OF THE INVENTION

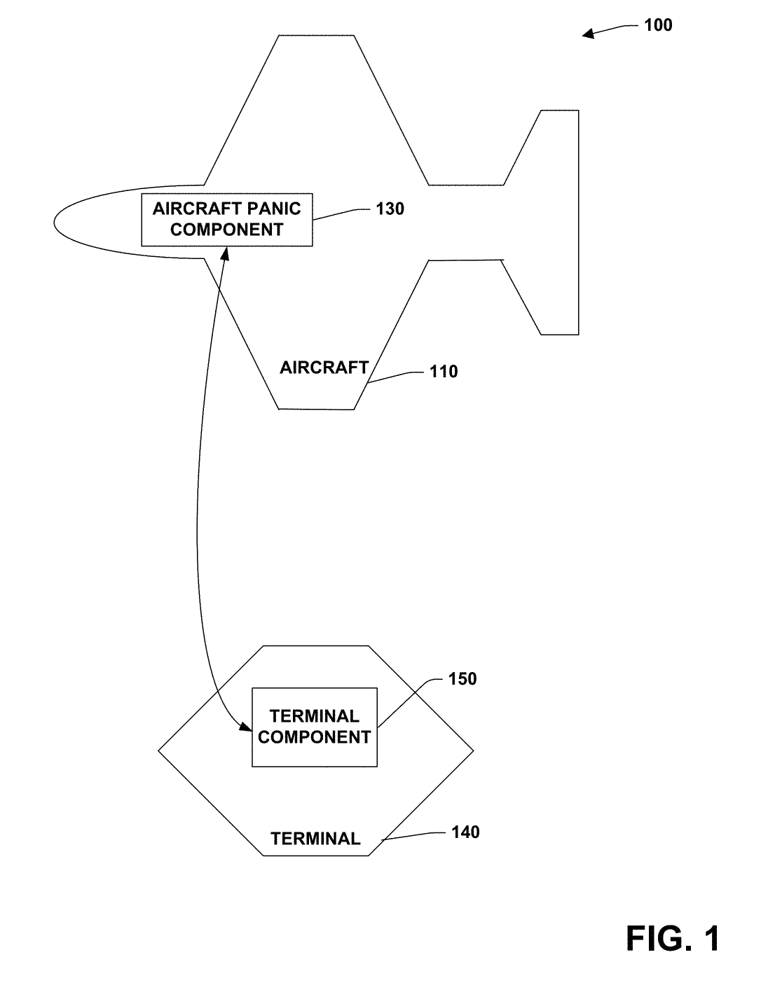

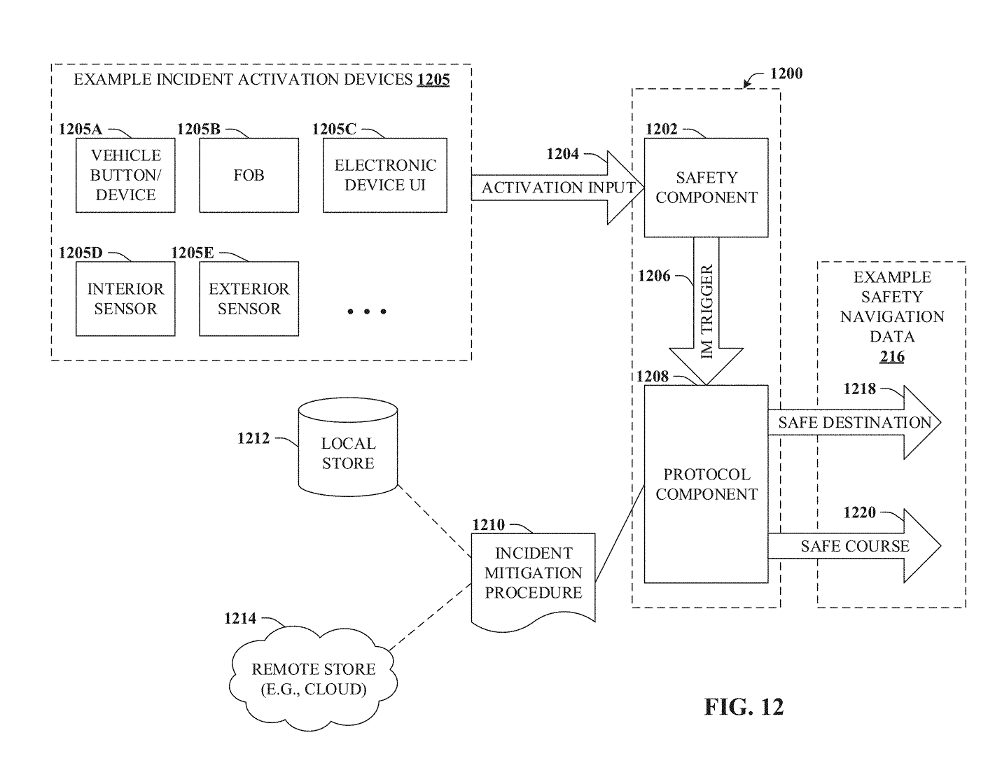

Subject matter described herein is generally directed to protocols for mitigating an unsafe condition. Systems that implement the disclosed techniques can reduce harm caused to person or property and also reduce the fear of such harm, which might otherwise prevent adoption of various technological advances. This disclosure is logically organized in two parts. The first part covers FIGS. 1-11 and details specific embodiments directed to an aircraft incident mitigation system. The second part covers FIGS. 12-19 and details more general embodiments of the incident mitigation system. For example, the second part is not specifically focused on aircraft embodiments, but rather details incident mitigation for vehicles in a more general sense as well as incident mitigation for services (e.g., transportation-as-a-service (TaaS), mobility-as-a-service (MaaS), lodging-as-a-service (LaaS), etc.) or incident mitigation for a vicinity of the vehicle or service.

Mitigating unsafe conditions can operate to reduce real threats to safety and can also operate to improve the perception of safety. Improving the perception of safety or alleviating safety fears can reduce potential market or regulatory roadblocks in the adoption of new technologies aimed at improving lives and economies. For example, autonomous cars present the market with several safety concerns, whether real or perceived. These safety concerns, however, tend to be greatly amplified for autonomous trucks, despite the fact that underlying technologies are fundamentally similar, and they share similar risk factors. As such, the adoption of autonomous truck technology is likely to advance more slowly than that of autonomous car products available in the market. Hence, in addition to mitigating incidents and improving safety, the disclosed subject matter can aid in overcoming biases or fears associated with some technological advances, which might allow autonomous car and truck technology to reach the market sooner and might allow additional biases or fears evoked by autonomous truck products to be overcome more readily, given the demonstrable improvement to safety.

### Part I: Aircraft Incident Mitigation Embodiments

The present invention is now described with reference to the drawings, wherein like reference numerals are used to refer to like elements throughout. In the following description, for purposes of explanation, numerous specific details are set forth in order to provide a thorough understanding of the present invention. It may be evident to one skilled in the art that the present invention may be practiced without these specific details. In other instances, well-known structures and devices are shown in block diagram form in order to facilitate description of the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component.

Referring to FIG. 1, a system for mitigating an aircraft incident 100 is illustrated. The system 100 includes an aircraft 110, an aircraft panic component 130, a terminal 140 and a terminal component 150. The terminal 140 can include an air traffic control system (not shown), air traffic controller(s) (not shown) and/or other system(s) and component(s) related to air traffic control and/or navigation of aircraft. The aircraft 110 can include a commercial, military and/or other aircraft system having at least one human aboard.

The aircraft panic component 130 facilitates identification of a panic situation. For example, a button, switch or other input device can be located in the cockpit, cabin and/or galley of the aircraft 110. In the event of a panic situation, such as a hijacking, a pilot and/or crew member can activate the button, switch other input device in order to identify a panic situation to the aircraft panic component 130. Once notified of a panic situation, the aircraft panic component 130 can at least partially disable the navigation system of the aircraft 110 and/or other operational functions of the aircraft 110 (e.g., fuel, airflow, fuel control and/or mix of breathable air). For example, the aircraft 110 can have its auto-pilot engaged taking the aircraft 110 (e.g., taking the aircraft to a certain altitude and/or heading), placed on a certain flight plan (e.g., toward a specific location), the aircraft 110 can have its auto-pilot temporarily engaged until control of the aircraft 110 is obtained remotely (e.g., by remote person and/or system) and/or navigated remotely (e.g., by a panic situation control center). Once the aircraft panic component 130 has been notified of a panic situation, navigation of the aircraft 110 cannot return back to “normal” (e.g., returning the at least partially disabled navigation system to control of the pilot) without receiving an appropriate signal and/or message from the terminal component 150. Accordingly, the decision to return the aircraft 110 to “normal” is taken away from the pilot. For example, control of substantially all of the navigational and/or operational system(s) can be taken away from the pilot and not returned to the pilot until and unless a signal and/or message has been received from the terminal component 150.

In accordance with an aspect of the present invention, during a panic situation, navigation system(s) and/or operational system(s) of the aircraft 110 can be operated remotely. For example, full control of the navigation system(s) and/or operational system(s) of the aircraft 110 can be turned over to remote person(s) and/or system(s) (e.g., land-based pilot and/or system). Alternatively, limited control of the navigation system(s) and/or operational system(s) of the aircraft 110 can be turned over to a remote person(s) and/or system(s) (e.g., land-based pilot and/or system). Further, while in a panic situation, it is to be appreciated the aircraft 110 can be landed remotely (e.g., without intervention of a pilot physically located within the aircraft 110).

The terminal component 150 is adapted to receive information (e.g., related to a panic situation) from the aircraft panic component 130. Optionally, the terminal component 150 can further be adapted to send information to the aircraft panic component 130 (e.g., return navigation to normal signal and/or message). The terminal component 150 can receive information from a human operator (e.g., air traffic controller) and/or computer system(s) (not shown). It is to be appreciated that in accordance with an aspect of the present invention, during flight, the aircraft 110 can be in contact with one or a plurality of terminal(s) 150 (e.g., airport terminal(s), panic situation control center(s), NORAD, SAC and/or other flight control center(s)).

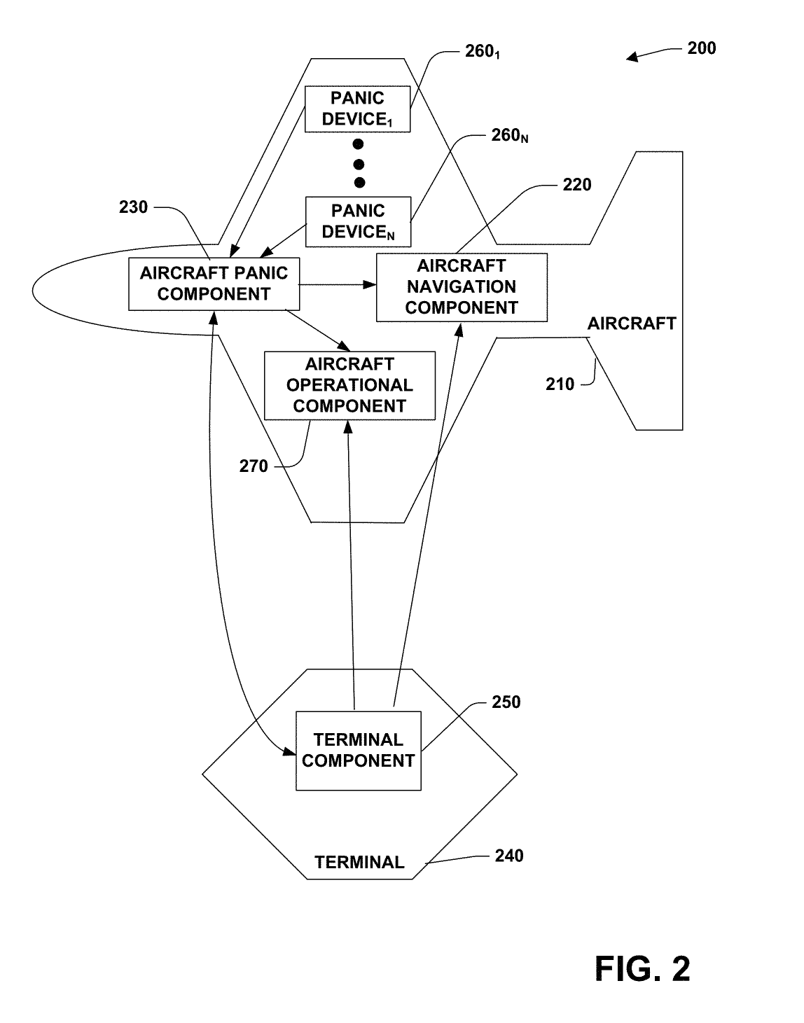

Next, referring to FIG. 2, a system for mitigating an aircraft incident 200 is illustrated. The system 200 includes an aircraft 210, an aircraft navigation component 220, an aircraft panic component 230, a terminal 240, a terminal component 250 and a first panic device 260₁ through an Nth panic device 260_{N}, N being an integer greater than or equal to one. The panic devices 260₁ through 260_{N} can be referred to collectively as the panic device 260. The terminal 240 can include an air traffic control system (not shown), air traffic controller(s) (not shown) and/or other system(s) and component(s) related to air traffic control and/or navigation of aircraft. The aircraft 210 can include a commercial, military and/or other aircraft system having at least one human aboard.

The aircraft navigation component 220 facilitates navigation of the aircraft 210. For example, the aircraft navigation component 220 can include the computer, electronic, electrical, hydraulic and/or pneumatic control system(s) comprising the navigational system of the aircraft 210.

Optionally, the aircraft 210 can include an aircraft operational component 270 which facilitates operational system(s) (e.g., fuel, pneumatic control, hydraulic and/or air pressure) of the aircraft 210.

The aircraft panic component 230 facilitates identification of a panic situation. Once notified of a panic situation, the aircraft panic component 230 can communicate the panic situation to the aircraft navigation component 220 which can at least partially disable the navigation system of the aircraft 210. Optionally, the aircraft panic component 230 can communicate the panic situation to the aircraft operational component 270. Further, the aircraft panic component can communicate information associated with the panic situation to the terminal component 250 (e.g., identify panic situation to air traffic controller). Based at least in part upon communication of the panic situation from the aircraft panic component 230, the aircraft navigation component 220 can place the aircraft 210 into appropriate safe zone (e.g., specific altitude, for example, 37,000 feet) which can be a restricted airspace, on a certain flight plan (e.g., toward a specific location) and/or permit the aircraft 210 to be navigated remotely (e.g., by a panic situation control center). Further, the aircraft operational component 270 can, optionally, facilitate placing one, some or substantially all of the aircraft operational system(s) to a predetermined state and/or a state based at least in part upon information received from the terminal component 250. Once the aircraft panic component 230 has been notified of a panic situation and communicated the panic situation to the aircraft navigation component 220, navigation of the aircraft 210 cannot return back to “normal” (e.g., returning the at least partially disabled navigation system to control of the pilot) without receiving an appropriate signal and/or message from the terminal component 250.

Accordingly, the decision to return the aircraft 210 to “normal” is taken away from the pilot. Further, optionally, operation of the aircraft operational system(s) can likewise not be returned to “normal” without receiving an appropriate signal and/or message from the terminal component 250.

The terminal component 250 is adapted to receive information (e.g., related to a panic situation) from the aircraft panic component 230. Optionally, the terminal component 250 can further be adapted to send information to the aircraft panic component 230 (e.g., return navigation to normal signal and/or message). The terminal component 250 can receive information from a human operator (e.g., air traffic controller), computer system(s) (not shown), military control center(s) and/or military computer system(s).

The panic device 260 can include a button, switch, iris scanner, thumb print reader and the like. In the event of a panic situation, such as a hijacking, a pilot and/or crew member can activate the panic device 260 in order to identify a panic situation to the aircraft panic component 230. It is to be appreciated that in accordance with the present invention, the panic device 260 can be coupled to the aircraft panic component 230 in a variety ways. For example, the panic device 260 can be electrically, wirelessly (e.g., via radio waves and/or infrared communication), pneumatically and/or hydraulically coupled to the aircraft panic component 260. It is to be understood and appreciated that the present invention is not limited by these examples and that any appropriate manner of identifying a panic situation to the aircraft panic component 230 is encompassed by this invention. In a system 200 comprising more than one panic device 260, the aircraft panic component 230 can determinate a panic situation has occurred based upon receiving a signal from a single panic device 260, a predetermined number of signals from panic devices 260 or receiving signals from all panic devices 260.

The panic device 260 can be located in the cockpit, galley and/or cabin. For example, a panic device 260 could be located at one, some or substantially all passenger seats. For example, a panic device 260 located at a passenger seat could signal a pre-panic situation requiring a crew member to override the pre-panic situation signal (e.g., within a predetermined period of time). If the crew member override is not performed timely, a panic situation is signaled. Further, a sky marshal can be equipped with a wireless (e.g., handheld) panic device 260.

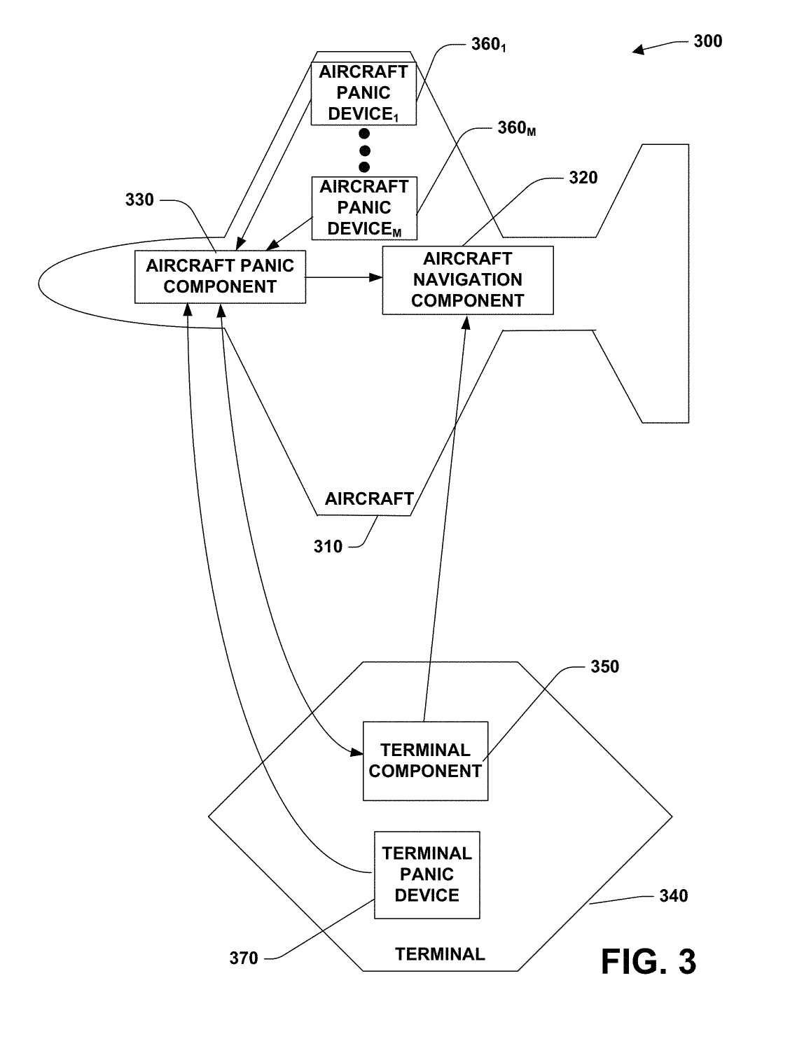

Turning to FIG. 3, a system for mitigating an aircraft incident 300 is illustrated. The system 300 includes an aircraft 310, an aircraft navigation component 320, an aircraft panic component 330, a terminal 340, a terminal component 350 and a terminal panic device 370. Optionally, the system 300 can include an aircraft panic device 3601 through an Mth panic device 360M, M being an integer greater to or equal to one. The panic devices 3601 through 360M can be referred to collectively as the panic device 360. The terminal 340 can include an air traffic control system (not shown), air traffic controller(s) (not shown) and/or other system(s) and component(s) related to air traffic control and/or navigation of aircraft. The aircraft 310 can include a commercial, military and/or other aircraft system having at least one human aboard.

The aircraft panic component 330 facilitates identification of a panic situation. The aircraft panic component 330 can obtain information related to the panic situation from the terminal panic device 370 and/or the aircraft panic device 360. Accordingly, a panic situation can be initiated from the aircraft 310 and/or the terminal 340. For example, an air traffic controller can initiate a panic situation utilizing a terminal panic device 370 (e.g., button and/or switch) if an improper response (e.g., voice code, unrecognized voice, message and/or signal) is received from the aircraft 310. Once notified of a panic situation, the aircraft panic component 330 can communicate the panic situation to the aircraft navigation component 320 which can at least partially disable the navigation system of the aircraft 310. Further, the aircraft panic component can communicate information associated with the panic situation to the terminal component 350 (e.g., identify panic situation to air traffic controller). Based upon at least in part upon communication of the panic situation from the aircraft panic component 330, the aircraft navigation component 320 can place the aircraft 310 into appropriate safe zone (e.g., specific altitude), on a certain flight plan (e.g., toward a specific location) and/or permit the aircraft 310 to be navigated remotely (e.g., by a panic situation control center). Once the aircraft panic component 330 has been notified of a panic situation and communicated the panic situation to the aircraft navigation component 320, navigation of the aircraft 310 cannot return back to “normal” (e.g., returning the at least partially disabled navigation system to control of the pilot) without receiving an appropriate signal and/or message from the terminal component 350. Accordingly, the decision to return the aircraft 310 to “normal” is taken away from the pilot.

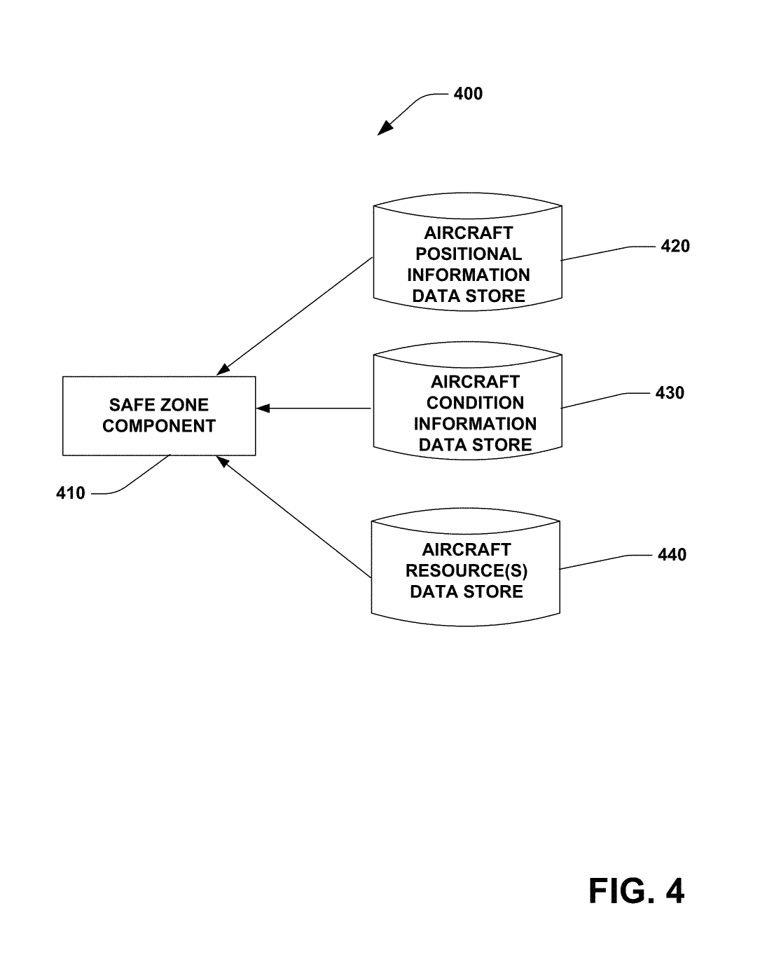

Turning to FIG. 4, a safe zone component 410 in accordance with an aspect of the present invention is illustrated. The safe zone component 410 includes aircraft positional information data store 420, aircraft condition information data store 430 and/or aircraft resource(s) data store 440.

The aircraft positional information data store 420 can store information associated with the geographical location and/or altitude of the aircraft.

The aircraft condition information data store 430 can store information associated with condition(s) of various component(s) of the aircraft. For example, the aircraft condition information data store 430 can store information (e.g., intact, temperature, pressure) with structural integrity of various parts of the aircraft (e.g., tail, wings, cargo hold, cockpit, cabin and/or galley). For example, the aircraft condition information data store 430 can store a most recent temperature and/or pressure of the cabin (e.g., received from appropriate sensor(s) (not shown).

The aircraft resource(s) data store 440 can store information associated with condition(s) of resource(s) of the aircraft. For example, the aircraft resource(s) can store information associated with fuel level(s).

The safe zone component 410 can be adapted to facilitate identification of a course of action for the aircraft in a panic situation. The safe zone component 410 can determine an appropriate safe zone (e.g., specific altitude), flight plan (e.g., toward a specific location) and/or permit the aircraft to be navigated remotely (e.g., by a panic situation control center). The safe zone component 410 can further have information related to geography and/or topology, for example, facilitating identification of air port(s) physically near the aircraft during the panic situation. For example, the safe zone component 410 can determine a course of action for the aircraft based at least in part upon aircraft positional information data store 420, aircraft condition information data store 430 and/or aircraft resource(s) data store 440.

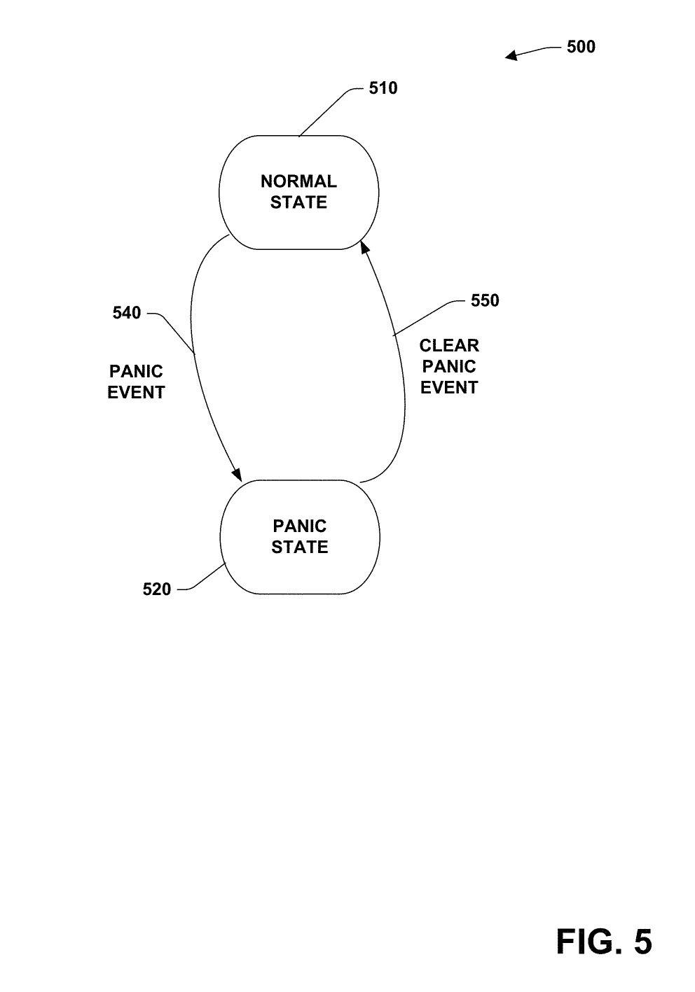

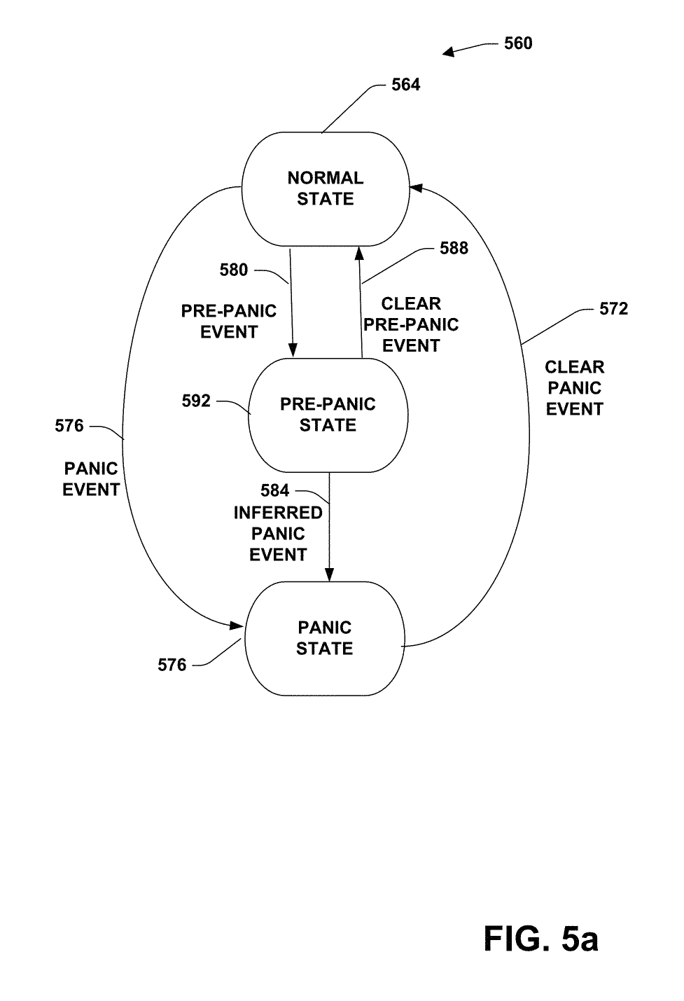

Referring next to FIG. 5, a state diagram of an aircraft incident mitigation system 500 in accordance with an aspect of the present invention is illustrated. As illustrated in the example of FIG. 5, an aircraft can have one of two states: normal state 510 and panic state 520. During general operation, the aircraft is in the normal state 510. In the event of a panic event 440 (e.g., hijacking), the aircraft is placed into the panic state 520. The aircraft does not return to the normal state 510 until and unless a clear panic event 550 occurs (e.g., an appropriate signal and/or message received from a terminal component). Next, referring to FIG. 5a, a state diagram of an aircraft incident mitigation system 560 in accordance with an aspect of the present invention is illustrated. As illustrated in the example of FIG. 5a, an aircraft can have one of three states: normal state 564, pre-panic state 592 and panic state 576. During general operation, the aircraft is in the normal state 564. In the event of a panic event 576 (e.g., hijacking), the aircraft is placed into the panic state 576 (e.g., by a crew member). The aircraft does not return to the normal state 564 until and unless a clear panic event 572 occurs (e.g., an appropriate signal and/or message received from a terminal component). Additionally, the aircraft can be placed in the pre-panic state 592 by a pre-panic event 580, for example, a pre-panic signal received from a passenger panic device. Once placed in the pre-panic state 592 affirmative action is required (e.g., by a crew member) in a predetermined period of time—a clear pre-panic event 588—canceling the pre-panic event 580. In the event the clear pre-panic event 588 is not timely received, the aircraft is placed into the panic state 592 by an inferred panic event 584.

It is to be appreciated that in accordance with the present invention an aircraft can be placed into additional states, for example, panic alert state and/or restricted state. These additional states can depend, for example, upon local, regional, national and/or global emergencies. These additional states can further depend upon information from governmental (e.g., Federal Aviation Authority), military (e.g., Army, Navy, Air Force and/or Marines) and/or civilian entities.

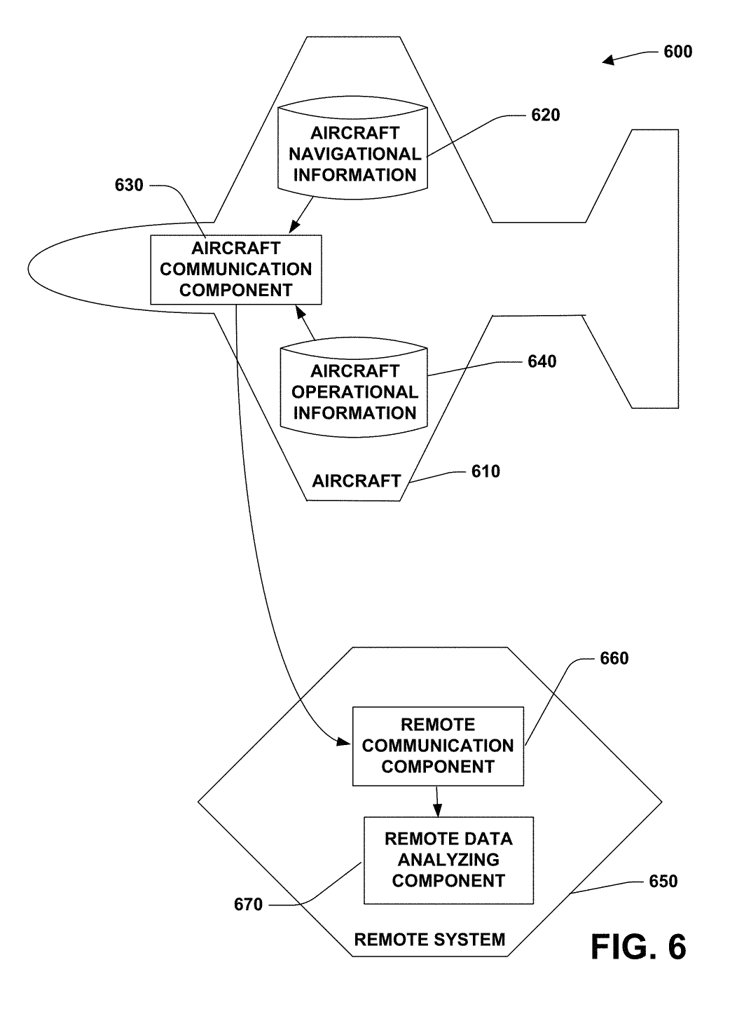

Turning to FIG. 6, a system for a mitigating aircraft incident 600 in accordance with an aspect of the present invention is illustrated. The system 600 includes an aircraft 610 coupled to a remote system 650. The aircraft 610 includes an aircraft communication component 630 facilitating transfer of information related to the aircraft to the remote system 650. The aircraft communication component 630 can be coupled to aircraft navigation information 620 and/or aircraft operational information 640.

The aircraft navigation information 620 can include information associated with navigation of the aircraft 610. The aircraft navigation information can include a log, database and/or other data store of navigation information, for example, a time-stamped record of airspeed and/or heading(s). The aircraft operational information 640 can include information associated with operation of the aircraft 610. The aircraft operational information can include a log, database and/or other data store of operational information, for example, fuel usage, an amount of fuel remaining, airflow, fuel control, mix of breathable air, cabin temperature(s).

The aircraft communication component 630 can further be adapted to communicate additional information to the remote system 650. For example, the aircraft communication component 630 can transfer image(s) and/or streaming video of the cockpit, cabin, galley, cargo hold and/or other area(s) of the aircraft 610.

The remote system 650 can include a remote communication component 660 facilitating transfer of information from the aircraft 610. The remote system 650 can further include a remote analyzing component 670 for analyzing information associated with the aircraft 610.

It is to be appreciated that information communicated from the aircraft communication component 630 and the remote communication component 660 can be performed at regular interval(s), at the request of the remote system 650, at the request of a pilot (not shown) and/or once a panic situation has occurred. By receiving information associated with the aircraft 610 (e.g., navigational and/or operational), remote person(s) and/or system(s) can be better equipped to handle aircraft panic situations.

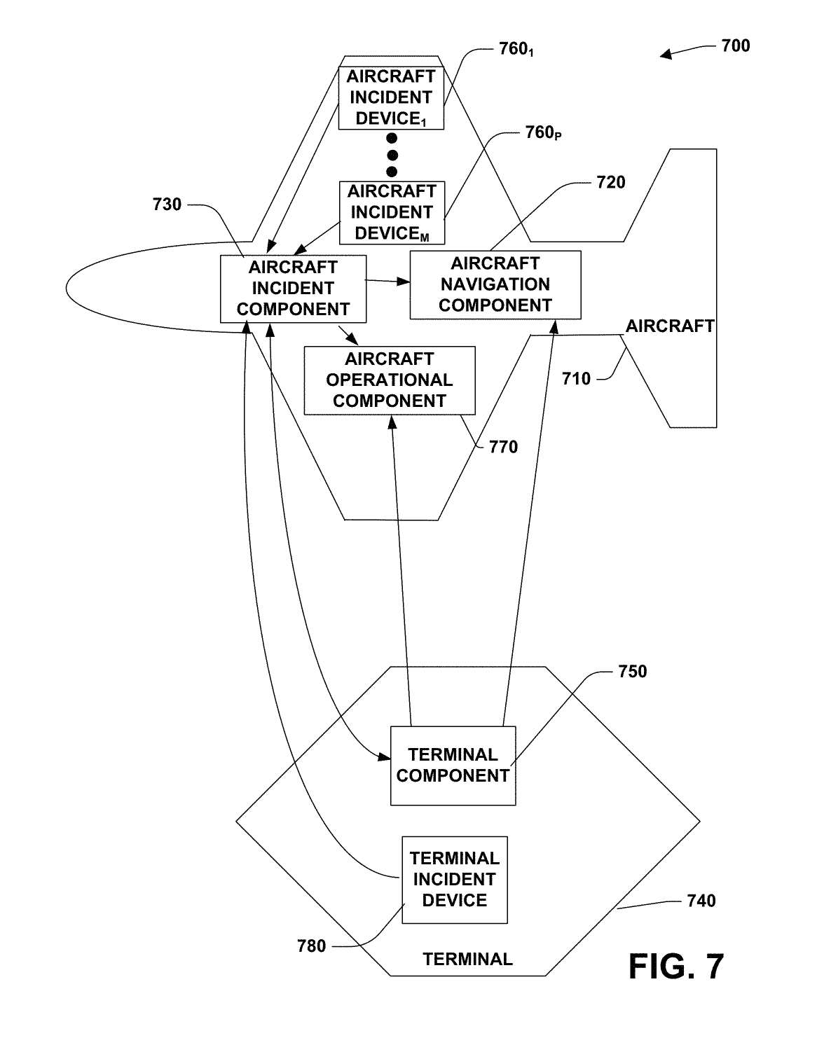

Referring to FIG. 7, a system for mitigating an aircraft incident 700 is illustrated. The system 700 includes an aircraft 710, an aircraft navigation component 720, an aircraft incident component 730, a terminal 740, a terminal component 750 and a terminal incident device 780. Optionally, the system 700 can include an aircraft incident device 7601 through a Pth incident device 760p, P being an integer greater to or equal to one. The aircraft incident devices 7601 through 760p can be referred to collectively as the incident device 760. The terminal 740 can include an air traffic control system (not shown), air traffic controller(s) (not shown) and/or other system(s) and component(s) related to air traffic control and/or navigation of aircraft. The aircraft 710 can include a commercial, military and/or other aircraft system having at least one human aboard. Optionally, the aircraft 710 can include can include an aircraft operational component 770 which facilitates operational system(s) (e.g., fuel, pneumatic control, hydraulic and/or air pressure) of the aircraft 710.

The aircraft incident component 730 facilitates identification of an incident. The incident can be related to a non-catastrophic situation, for example, loss of a redundant component such as an engine, an emergency, for example, a pilot becoming ill and/or a catastrophic situation. The aircraft incident component 730 can obtain information related to the incident from the terminal incident device 780 and/or the aircraft incident device 760. Accordingly, an incident can be initiated from the aircraft 710 and/or the terminal 740. For example, an air traffic controller can initiate an incident utilizing a terminal incident device 780 (e.g., button and/or switch) if an improper response (e.g., voice code, unrecognized voice, message and/or signal) is received from the aircraft 710. Once notified of the incident, the aircraft incident component 730 can communicate information associated with the incident to the aircraft navigation component 720 which can facilitate corrective and/or emergency course(s) of action. For example, the aircraft navigation component 720 can, at least temporarily, engage the auto-pilot system(s) in during an illness of a pilot. Further, the aircraft incident component 730 can communicate information associated with the incident to the terminal component 750 (e.g., identify incident to air traffic controller). Based upon at least in part upon communication of the incident from the aircraft incident component 730, the aircraft navigation component 720 can place the aircraft 710 into appropriate course of conduct (e.g., take air craft to a specific altitude, put aircraft on a certain flight plan—toward a specific location and/or permit the aircraft 710 to be navigated remotely).

Optionally, the aircraft incident component 730 can communicate information associated with the incident to the aircraft operational component 770. The aircraft operational component 770 can facilitate placing one, some or substantially all of the aircraft operational system(s) to a predetermined state and/or a state based at least in part upon information received from the terminal component 750 and/or aircraft incident component 730.

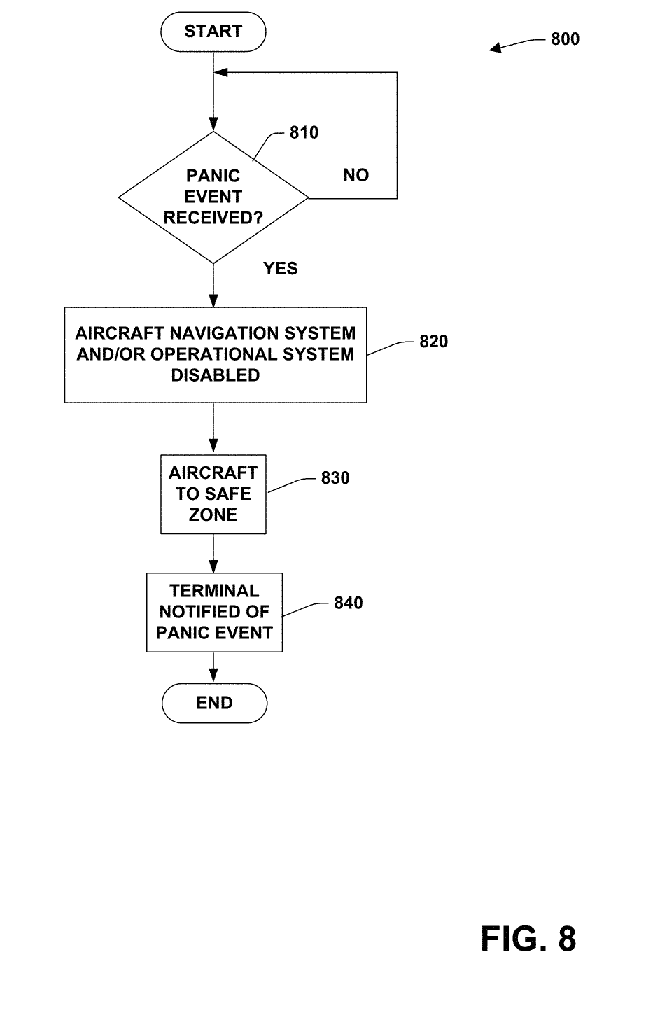

In view of the exemplary systems shown and described above, methodologies which may be implemented in accordance with the present invention, will be better appreciated with reference to the flow charts of FIGS. 8, 9, 10 and 11. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement a methodology in accordance with the present invention. In addition, it will be appreciated that the exemplary methods 700, 800, 900 and 1000 and other methods according to the invention may be implemented in association with the aircraft incident mitigating system illustrated and described herein, as well as in association with other systems and apparatus not illustrated or described.

The invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Turning to FIG. 8, a methodology 800 for mitigating an aircraft incident in accordance with an aspect of the present invention is illustrated. At 810, a determination is made whether a panic event has been received. If the determination at 810 is NO, processing continues at 810. If the determination at 810 is YES, at 820, the aircraft navigation and/or operational system(s) are disabled—partially or substantially completely. At 830, the aircraft is sent to a safe zone (e.g., based upon a safe zone component and/or an aircraft panic component). At 840, a terminal is notified of the panic event.

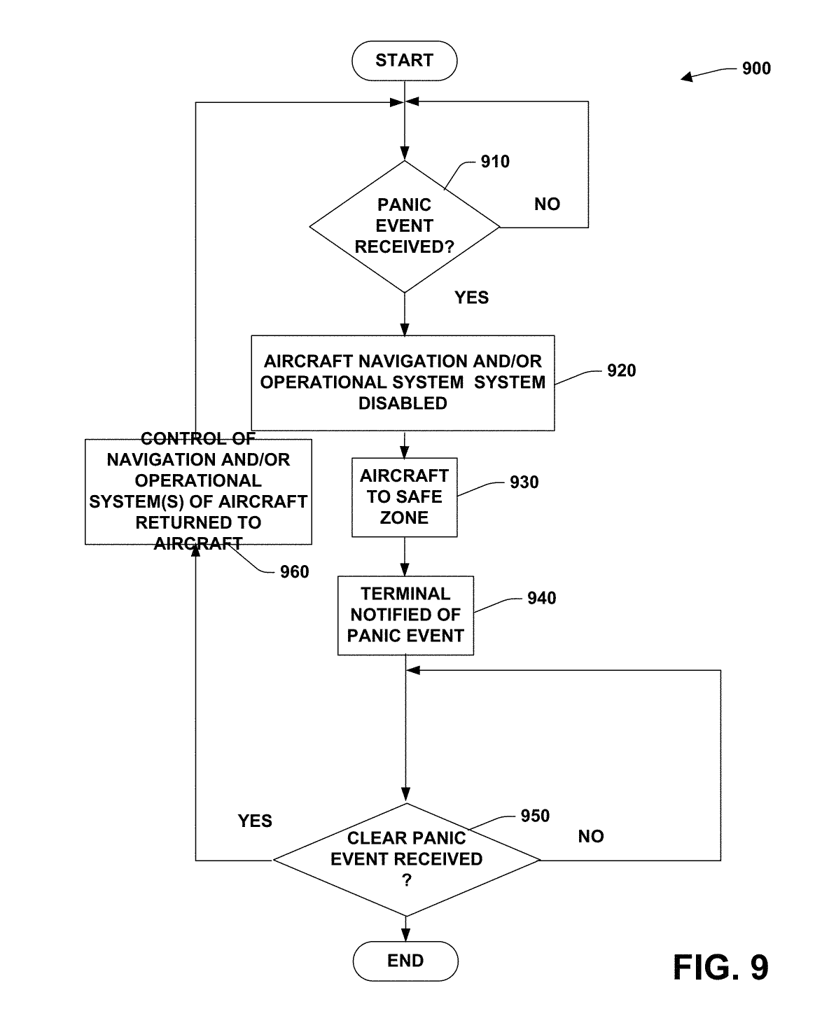

Referring to FIG. 9, a methodology 900 for mitigating an aircraft incident in accordance with an aspect of the present invention is illustrated. At 910, a determination is made whether a panic event has been received. If the determination at 910 is NO, processing continues at 910. If the determination at 910 is YES, at 920, the aircraft navigation and/or operational system(s) are disabled. At 930, the aircraft is sent to a safe zone (e.g., based upon a safe zone component and/or an aircraft panic component). At 940, a terminal is notified of the panic event. At 950, a determination is made whether a clear panic event message has been received (e.g., from the terminal). If the determination at 950 is YES, at 960, control of the navigation and/or operational system(s) of the aircraft are returned to the aircraft and processing continues at 910. If the determination at 950 is NO, processing continues at 950.

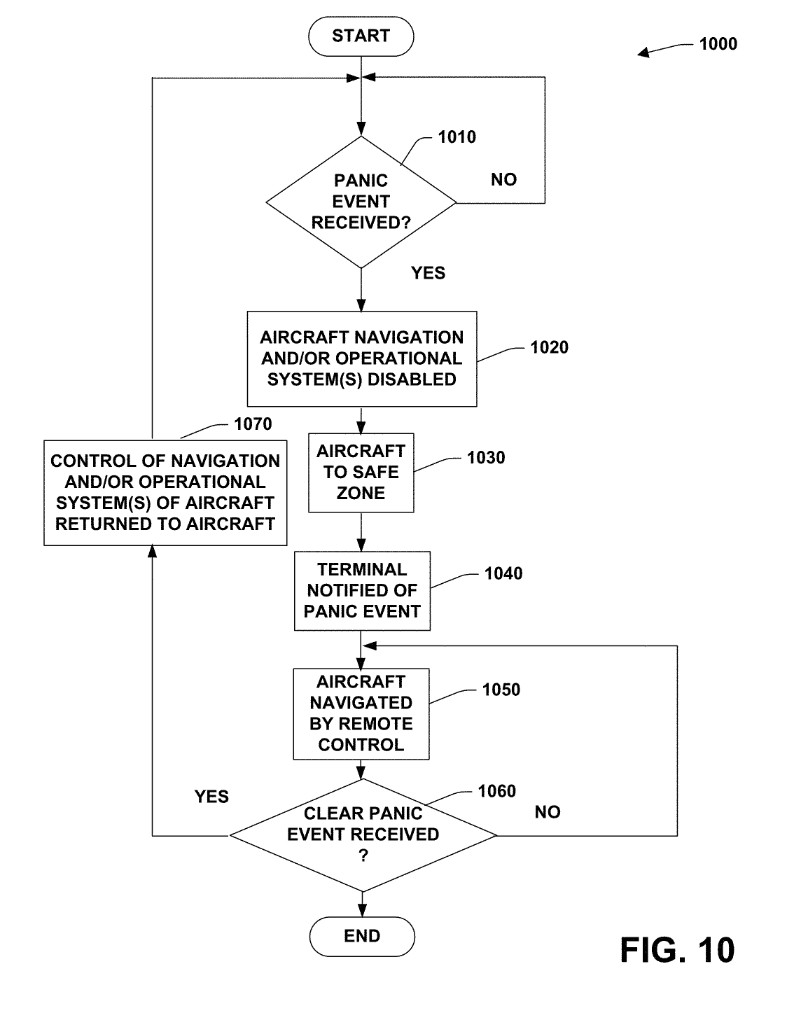

Next, referring to FIG. 10, a methodology 1000 for mitigating an aircraft incident in accordance with an aspect of the present invention is illustrated. At 1010, a determination is made whether a panic event has been received. If the determination at 1010 is NO, processing continues at 1010. If the determination at 1010 is YES, at 1020, the aircraft navigation and/or operational system(s) are disabled. At 1030, the aircraft is sent to a safe zone (e.g., based upon a safe zone component and/or an aircraft panic component). At 1040, a terminal is notified of the panic event. At 1050, the aircraft is navigated by remote control (e.g., from the terminal and/or a aircraft incident control center). At 1060, a determination is made whether a clear panic event message has been received. If the determination at 1060 is YES, at 1070, control of the navigation and/or operational system(s) of the aircraft are returned to the aircraft and processing continues at 1010. If the determination at 1060 is NO, processing continues at 1050.

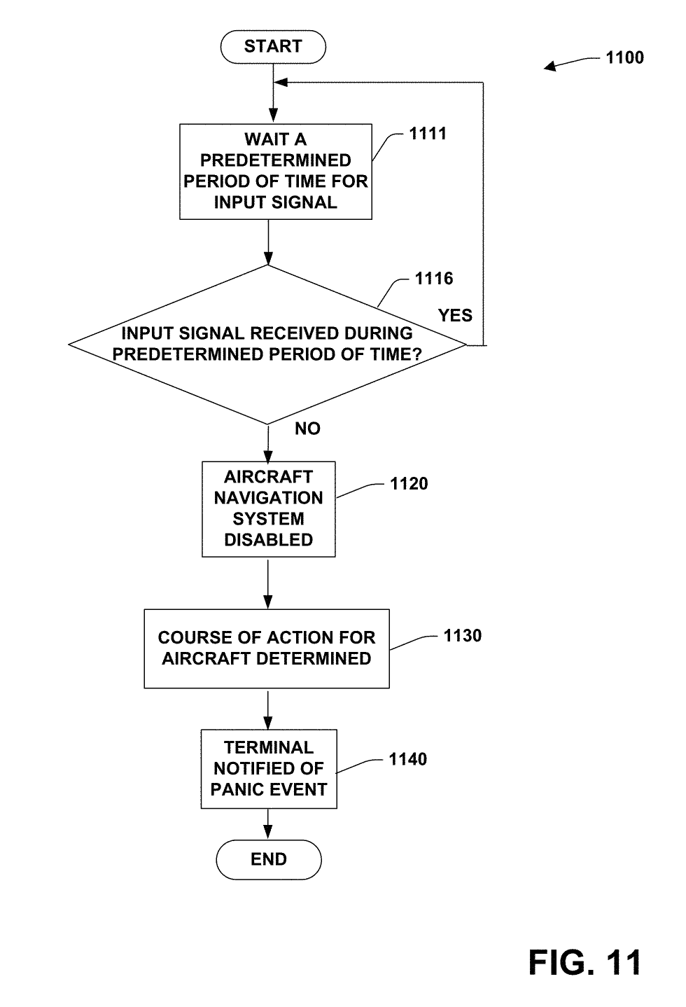

Turning to FIG. 11, a methodology 1100 for mitigating an aircraft incident in accordance with an aspect of the present invention is illustrated. At 1110, a predetermined period of time (e.g., 11 minutes) is waited. At 1116, a determination is made whether an input signal (e.g., appropriate operator iris scanned, thumb print detected, voice signal received, button depressed and/or other affirmative action) has been received during the predetermined period of time. If the determination at 1116 is YES, processing continues at 1110. If the determination is NO, at 1120, the aircraft navigation system, at least partially, is disabled (e.g., a panic event declared). At 1130, a course of action for the aircraft is determined (e.g., based upon a safe zone component and/or an aircraft panic component). At 1140, a terminal is notified of the panic event.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising.”

### Part II: Further Vehicle, Vicinity, or Services Embodiments

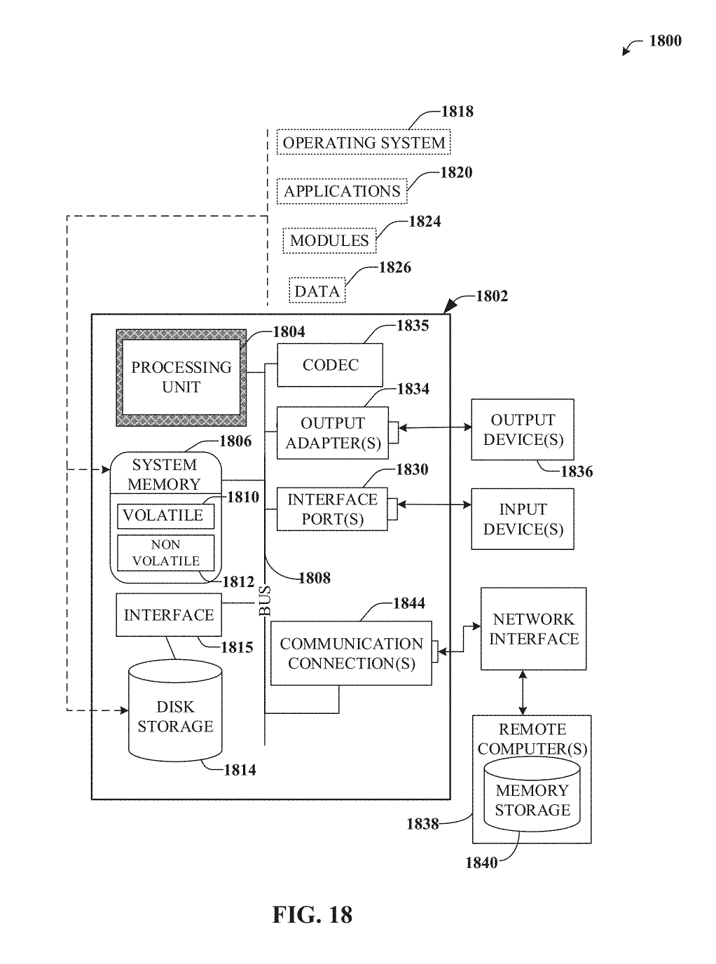

Referring now to FIG. 12, a block diagram is depicted of an example, non-limiting system 1200 that can mitigate an unsafe condition for a vehicle in accordance with one or more embodiments of the disclosed subject matter. It should be understood that in the discussion of the present embodiment and of embodiments to follow, repetitive description of like elements employed in the various embodiments described herein is omitted for sake of brevity. System 1200 can comprise a processor and a memory that stores executable instructions that, when executed by the processor, facilitate performance of operations. Examples of said processor and memory, as well as other suitable computer or computing-based elements, can be found with reference to FIG. 18, and can be used in connection with implementing one or more of the systems or components shown and described in connection with FIG. 12 or other figures disclosed herein.

System 1200 can comprise safety component 1202. Safety component 1202 can be configured to receive activation input 1204. Activation input 1204 can be provided by one or more incident activation devices 1205, non-limiting examples of which are illustrated as devices 1205A-E. In some embodiments, incident activation device 1205 can be included in system 1200. In other embodiments, incident activation device 1205 can be remote from and communicatively coupled to system 1200. A representative example of an incident activation device 1205 is what is referred to herein as a “panic button”. Pressing the panic button can signal that an unsafe condition exists and can result in transmission of activation input 1204 to safety component 1202.

While a panic button is used as representative, it is appreciated that any user interface (UI) element such as buttons, switches, levers, knobs, sliders, voice activation, gestures, and so forth can be employed. Further, incident activation device 1205 can be a physical object, a graphical UI element, or any suitable means or mechanism to provide activation input 1204. In some embodiments, activation input 1204 is transmitted to safety component 1202 in response to manual input by a user (e.g., a user presses a button that signals an unsafe condition). Representative examples are devices 1205A-C. In some embodiments, activation input 1204 is transmitted to safety component 1202 in response to machine-based detection of the unsafe condition. Such can be based on monitoring performed by a sensor (e.g., camera, microphone, biometric monitor, collision detection element, etc.) or other device, with devices 1205D-E being representative examples. Additional detail regarding incident activation devices 1205 is provided below in the context of various use case examples.

Hence, one or more activation devices 1205, for instance in response to input or monitoring, can transmit activation input 1204 to safety component 1202. In response to receipt of activation input 1204, safety component 1202 can trigger incident mitigation (IM) procedure 1206. IM procedure 1206 can be a procedure determined to mitigate an unsafe condition for a vehicle that is in operational use. As used herein, the term “vehicle” can be any suitable device or mechanism capable of locomotion, including aircraft and automobiles, with a representative example in this section of the disclosure being an automobile. In some embodiments, the vehicle can be capable of manual operation, either locally or remotely controlled or navigated. In some embodiments, the vehicle can be capable of autonomous operation, control, or navigation, e.g., driverless cars, unmanned vehicles (UVs) unmanned aerial vehicles (UAVs), manually operated vehicles with autonomous elements (e.g., autonomous parking, autonomous navigation, autonomous collision avoidance, etc.).

System 1200 can further comprise protocol component 1208 that can be configured to execute IM procedure 1210. IM procedure 1210 can represent a configurable set of defined protocols, instructions, policies, or other rules that can mitigate the unsafe condition. In some embodiments, all or a portion of IM procedure 1210 can be stored locally to system 1200, as illustrated by local store 1212. In some embodiments, all or a portion of IM procedure 1210 can be stored remotely such as in a cloud-based remote store 1214. IM procedure 1210 can be configurable and thus can evolve according to machine-learning techniques or based on history, experience, regulation, and so forth. Furthermore, a particular IM procedure 1210 can be selected based on a type of unsafe condition or a particular scenario or implementation.

Regardless, in executing IM procedure 1210, protocol component 1208 can determine safety navigation data 216. Safety navigation data 216 can comprise and/or can be representative of safe destination 1218 and safe course 1220. Safe destination 1218 can be a destination for the vehicle at which it is determined to be safe to terminate the operational use. For example, determined safe to terminate or disable one or both of control systems of the vehicle and navigation systems of the vehicle.

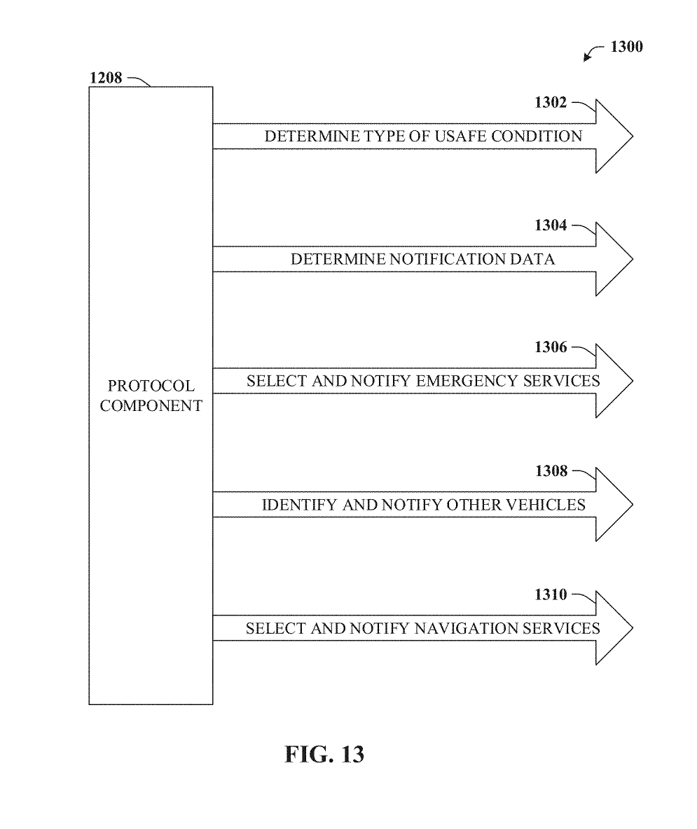

Safe course 1220 can be a course by which to navigate the vehicle to the safe destination that is determined to be safe. For example, consider an automobile traveling in traffic at a significant speed when activation input 1204 is received indicating an unsafe condition. Immediately stopping the vehicle, in traffic, is likely not a safe alternative. Rather, a destination (e.g., safe destination 1218) of a shoulder of an exit ramp that is half a mile ahead might be selected. Safe course 1220 can include a course that carefully switches lanes in the traffic and navigates to safe destination 1218, where, if suitable, certain systems of the vehicle can be disabled or activated and, again if suitable, an emergency service entity or other entities can be notified. Additional examples are provided in connection with FIG. 13.

Turning now to FIG. 13, system 1300 is depicted. System 1300 illustrates a first example of additional aspects or elements of the incident mitigation system in accordance with one or more embodiments of the disclosed subject matter. For example, system 1300 illustrates a first group of additional protocols that can be implemented in connection with IM procedure 1210. For example, the IM procedure 1210 (e.g., executed by protocol component 1208) can comprise determining a type of the unsafe condition, which can be employed to select a particular IM procedure as well as for other purposes. For example, in a TaaS driverless car scenario, one unsafe condition might arise for a passenger due to a malfunction of the vehicle. In that case, the passenger might press a panic button (e.g., device 1205A) located in passenger portions of the vehicle, which can invoke a particular IM procedure 1210 based on that type of unsafe condition.

As another example, consider a vicinity-based scenario in which it is observed that a third-party vehicle is being operated erratically. Such might be observed by a sensor of a different vehicle or device (e.g., device 1205E), by a bystander, or an operator or passenger of another vehicle, which might be signaled by interacting with a UI element of a fob device (e.g., device 1205B) or of a smart phone or other electronic device (e.g., device 1205C) running an associated application. Such would likely represent a very different unsafe condition with different mechanisms for mitigating and thus might result in selection of a different IM procedure 1210.

For example, a significant concept employed by IM procedure 1210 in some embodiments is that of notification. Thus, as illustrated by reference numeral 1304, protocol component 1208 can determine notification data 1304. Notification data can comprise, e.g., an identification of the vehicle (e.g., the malfunctioning vehicle in the first scenario above or the erratic vehicle in the second scenario, etc.), a current location of the vehicle, a projected destination of the vehicle, and so forth. In some cases (e.g., in the first scenario above) the projected destination can be safe destination 1218.

Further, as indicated by reference numeral 1306, in some embodiments, an emergency services entity can be selected, and a device of the emergency services entity notified. In some embodiments, the emergency services entity can be selected based on the type of the unsafe condition detailed in connection with determination 1302.

Apart from notification of an emergency services entity, other entities can be notified, any or all of which can be determined on a case-by-case bases depending on the scenario or implementation. For example, in some embodiments, IM procedure 1210 can further comprise an instruction for transmitting a notification of the unsafe condition (e.g., notification data) to other vehicles, indicated by reference numeral 1308. Additionally, or alternatively, in some embodiments, IM procedure 1210 can further comprise an instruction for transmitting a notification of the unsafe condition and/or the notification data to a device of a navigation services entity, indicated by reference numeral 1310.

For instance, consider again the case of an unsafe condition arising for a first vehicle that observes a second vehicle in the immediate vicinity being operated erratically. The first vehicle can trigger an IM procedure 1210, which can result in the determinations of a safe destination 1218 and safe course 1220 for the first vehicle to avoid risk caused by proximity to the erratically operated second vehicle. Furthermore, IM procedure 1210 can facilitate notification of a device of an appropriate emergency services entity (e.g., police, towing, medical or fire, etc.) depending on the state of the environment (e.g., collisions detected, disabled vehicles detected, etc.). IM procedure 1210 might also notify other vehicles of the unsafe condition, e.g., so that the other vehicles can avoid the area or take other remedial measures such as implementing their own IM procedure 1210. Additionally, or alternatively, IM procedure 1210 might notify a device of a navigation service (e.g., Waze, Apple Maps, Google Maps, Microsoft Maps, etc.) of the unsafe condition. Accordingly, even vehicles not equipped with elements of the disclosed subject matter can be informed by a third-party navigation service of the unsafe condition and/or be navigated by the third-party service to avoid the area.

When notifying other vehicles of the unsafe condition, an appropriate set of other vehicles can be selected, which can be selected based on a vicinity determination, a trajectory determination, or otherwise. For example, in some embodiments, the other vehicles to be notified can be determined to be those vehicles in a vicinity of a current location of the vehicle (e.g., that is the source or cause of the unsafe condition). The vicinity can be determined based on a defined distance from the current location (e.g., within 0.5 miles of the unsafe condition and/or the offending vehicle). In some embodiments, the other vehicles to be notified can be determined to be those vehicles estimated to reach the vicinity within a defined time (e.g., within 15 minutes). Estimations about vehicles reaching the vicinity can be based on a corresponding plotted navigation course for the associated vehicle.

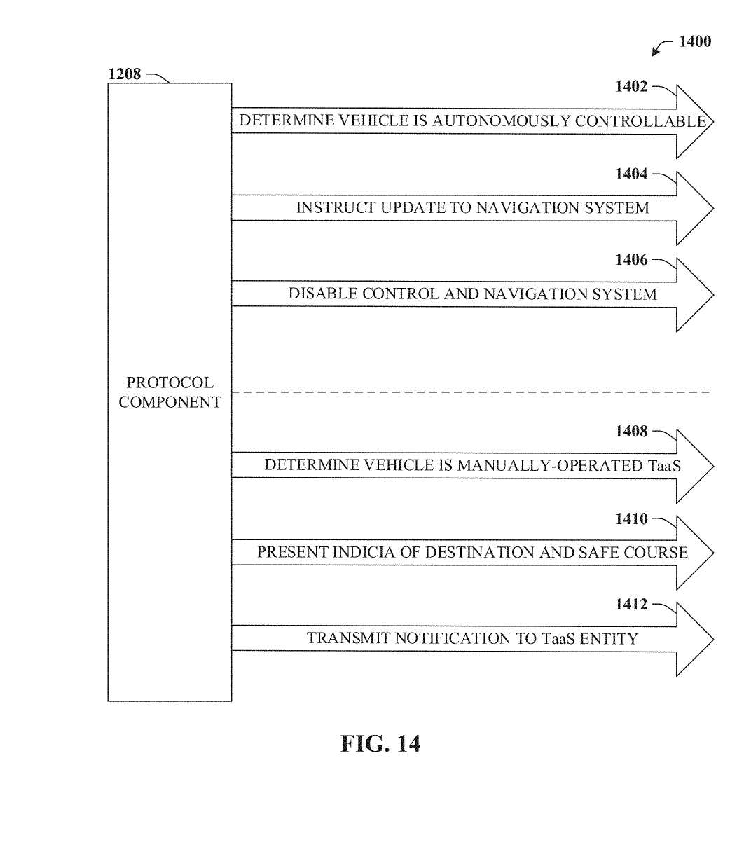

It is understood that the other vehicles notified can also include a vehicle that is the source or cause of the unsafe condition (e.g., the erratically operated vehicle), which can allow that vehicle to trigger an IM procedure 1210. Thus, in some embodiments, system 100 and/or protocol component 1208 can represent an incident activation device 1205, as protocol component 1208 might transmit notification data or other information that can represent activation input 1204 that can result in IM trigger 1206. Regardless of the source of activation 1204 or whether a given vehicle is a cause of, or otherwise potentially exposed to, the unsafe condition, IM procedure 1210 can include additional elements that can be executed based on different scenarios, which is further described in connection with FIG. 14.

Referring now to FIG. 14, system 1300 is depicted. System 1400 illustrates a second example of additional aspects or elements of the incident mitigation system in accordance with one or more embodiments of the disclosed subject matter. For instance, system 1400 depicts two example situation-based scenarios. In the first scenario, illustrated by the upper portions of FIG. 14, protocol component 1208 executes additional elements based on the situation in which the vehicle is determined to be autonomously controllable, illustrated by reference numeral 1402. As noted, an autonomously controllable vehicle can include a driverless/operatorless vehicle as well as a vehicle with at least limited autonomous control (e.g., collision avoidance, etc.) that can be activated in response to suitable triggers.

Protocol component 1208 can further instruct a navigation system of the autonomously controllable vehicle to update an existing course with safe course 1220, which is illustrated by reference numeral 1404. In the case of an operatorless vehicle, the vehicle can now proceed, autonomously or otherwise, according to safe course 1220 irrespective of the previously existing course that was plotted prior to detection of the unsafe condition. If deemed appropriate for the specific situation by IM procedure 1210, upon arrival at safe destination 1218 (e.g., via safe course 1220), the autonomously controllable vehicle can be instructed to disable a vehicle control system and/or the navigation system, as illustrated by reference numeral 1406. Such might represent a disabling of control and/or navigation input devices or an instruction to ignore or refuse to respond to or accept the input. In other words, new courses cannot be locally plotted and/or at least some systems of the vehicle cannot be locally controlled. In some embodiments, remote control or navigation might still be accepted.

In the second scenario, illustrated by the lower portions of FIG. 14, protocol component 1208 executes additional elements based on the situation in which the vehicle is determined to be a manually-operated vehicle being operated according to an agreement with a TaaS entity, illustrated by reference numeral 1408. However, it is appreciated that some of the elements to follow might also be applicable for any manually operated vehicle or a vehicle with limited autonomous controllability.

As illustrated at reference numeral 1410, protocol component 1208 can present to an operator of the manually-operated vehicle indicia indicating safe destination 1218 and safe course 1220. In some embodiments, the indicia can be visually presented to UI of the vehicle or a UI of a different device (e.g., an electronic device 1205C of the operator executing a suitable application). In some embodiments, the indicia can be audible that is presented by speakers or other suitable equipment of the vehicle or the different device. Furthermore, in some embodiments, protocol component 1208 can transmit a notification of the unsafe condition (e.g., the notification data) to a device of the TaaS entity, which can take remedial measures according to their own policies.

For example, consider the cases where a driver/operator for the TaaS entity exhibits threatening behavior or where a passenger exhibits threatening behavior. Such might be detected by an interior sensor of the vehicle (e.g., device 1205D) or by suitable input to a panic button situated in either one of the operator or passenger portions of the vehicle, or by a fob or electronic device (e.g., any of devices 1205A-C). By alerting the TaaS entity, additional safety measure can be enacted, which can improve safety as well as the perception of safety. The benefits of improving safety are self-evident, and additional advantages of the disclosed subject matter can arise by improving perceptions, particularly in the face of new technologies that might not be sufficiently vetted or otherwise provoke real or perceived fear in potential market actors. Such real or perceived fear can provoke regulation or perceptions adverse to the success of many new technologies. Safety measure detailed herein can help mitigate those fears and thus improve the potential adoption and/or market penetration of many new vehicle-based technologies, including TaaS, driverless cars, and so on as well as vicinity based technologies such as lodging-as-a-service (LaaS) or the like.

It is further understood that inferences about the type of unsafe condition can be made based on the source of activation input 1204. For example, a different set of likely unsafe conditions can be identified when activation input 1204 comes from a personal device of a passenger than those likely unsafe conditions detected by a sensor or signaled by a button proximal to the operator. In other words, IM procedure 1210 can determine the type of the unsafe condition based at least in part on the incident activation device 1205 that generated activation input 1204.

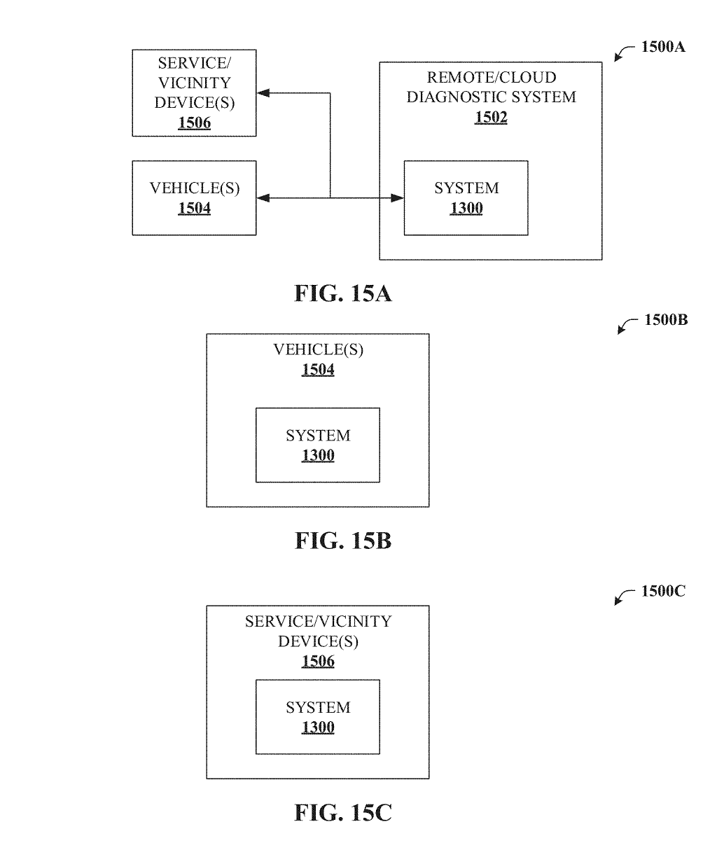

Turning now to FIGS. 15A-C, various block diagrams 1500A-C of example architectural implementations are illustrated in accordance with one or more embodiments of the disclosed subject matter.

For example, block diagram 1500A depicts an example architectural design in which all or portions of system 1300 (or other components detailed herein) are remote from one or more vehicles 1504 and/or various service or vicinity devices 1506. For example, system 1300 can reside in a cloud diagnostic system 1502 and communicate with vehicles 1504 or devices 1506 via a wireless communication framework. Vehicles 1504 can refer to any suitable vehicle that is in a vicinity of the unsafe condition or may enter the vicinity and can include incident activation device 1205A, 1205D, 1205E, or others. Service/vicinity devices 1506 can refer to any suitable device such as incident activation devices 1205B, 1205C, or others.

In contrast to the architecture depicted in FIG. 15A in which system 1300 resides in remotely such as in a cloud, FIGS. 15B and 15C illustrate architectures in which system 1300 can reside in devices proximal to the unsafe condition. For instance, block diagram 1500B depicts an example architectural design in which all or portions of system 1300 (or other components detailed herein) are included in vehicles 1504.

Block diagram 1500C depicts an example architectural design in which all or portions of system 1300 (or other components detailed herein) are included in service/vicinity devices 1506.

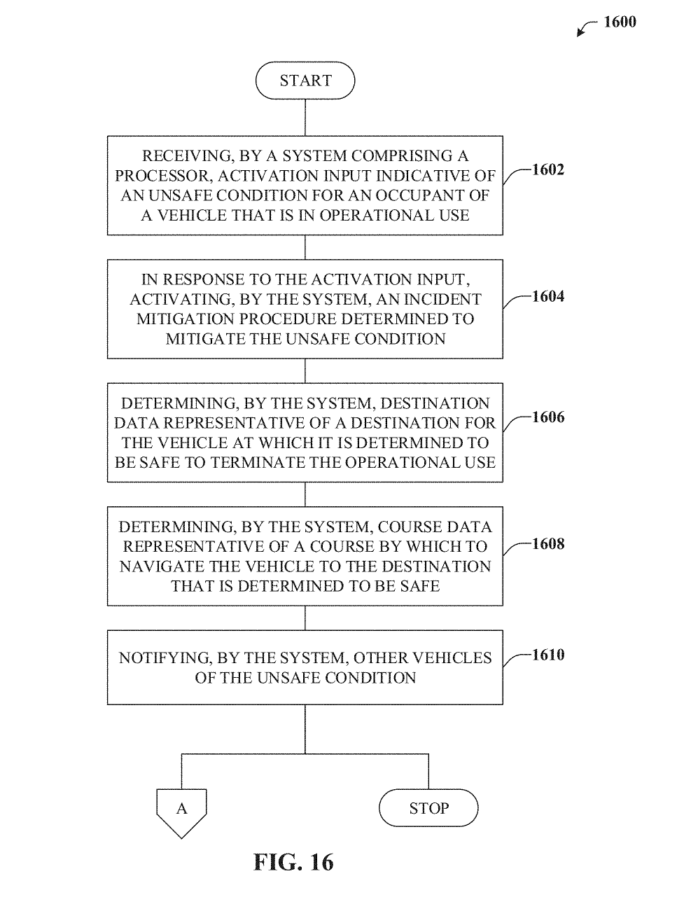

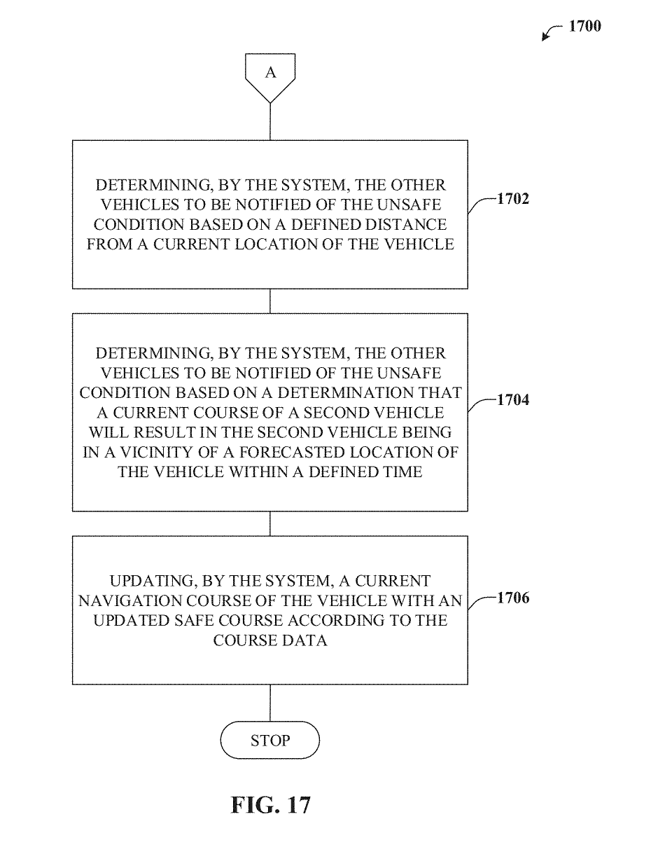

FIGS. 16 and 17 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

FIG. 16 illustrates a flow diagram 1600 of an example, non-limiting computer-implemented method that can mitigate danger caused by an unsafe condition in accordance with one or more embodiments of the disclosed subject matter. For example, at reference numeral 1602, a device (e.g., safety component 1202) operatively coupled to a processor can receive activation input indicative of an unsafe condition for an occupant of a vehicle.

At reference numeral 1604, in response to the activation input, the device can activate an incident mitigation procedure determined to mitigate the unsafe condition. The incident mitigation procedure can comprise various instructions that can be executed. For example, the incident mitigation procedure can comprise instructions detailed at reference numerals 1606-1610.

At reference numeral 1606, the device can determine destination data representative of a destination for the vehicle at which it is determined to be safe from danger presented by the unsafe condition. In some embodiments, the destination can be a destination in which it is determined to be safe to terminate operational use of the vehicle.

At reference numeral 1608, the device can determine course data representative of a course by which to navigate the vehicle to the destination that is determined to be safe. At reference numeral 1610, the device can notify other vehicles of the unsafe condition, which is further detailed in connection with FIG. 17. Method 1600 can proceed to insert A, which is discussed in connection with Method 1700 of FIG. 17 or stop.

Turning now to FIG. 17, illustrated is a flow diagram 1700 of an example, non-limiting computer-implemented method that can provide for additional aspects or elements in connection with mitigating danger caused by an unsafe condition in accordance with one or more embodiments of the disclosed subject matter. For example, Reference numeral 1610 of FIG. 16 describes elements of notifying other vehicles. The other vehicles that are notified can be determined based on various conditions, examples of which are provided at reference numerals 1702 and 1704.

For instance, at reference numeral 1702, the device can determine the other vehicles to be notified of the unsafe condition based on a defined distance from a current location of the vehicle.

At reference numeral 1704, the device can determine the other vehicles to be notified of the unsafe condition based on a determination that a current course of a second vehicle will result in the second vehicle being in a vicinity of a forecasted location of the vehicle within a defined time.

At reference numeral 706, the device can update a current navigation course of the vehicle with an updated safe course according to the course data. In other words, the navigation course of the vehicle can be changed to avoid the unsafe condition.

It is understood that the present invention can be a system, a method, and/or a product form by a specified process. Certain technical applications of the invention can be provided by a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create ways for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 18, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 18, an example environment 1800 for implementing various aspects of the claimed subject matter includes a computer 1802. The computer 1802 includes a processing unit 1804, a system memory 1806, a codec 1835, and a system bus 1808. The system bus 1808 couples system components including, but not limited to, the system memory 1806 to the processing unit 1804. The processing unit 1804 can be any of various available processors. Dual microprocessors and other multiprocessor architectures also can be employed as the processing unit 1804.

The system bus 1808 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1806 includes volatile memory 1810 and non-volatile memory 1812, which can employ one or more of the disclosed memory architectures, in various embodiments. The basic input/output system (BIOS), containing the basic routines to transfer information between elements within the computer 1802, such as during start-up, is stored in non-volatile memory 1812. In addition, according to present innovations, codec 1835 can include at least one of an encoder or decoder, wherein the at least one of an encoder or decoder can consist of hardware, software, or a combination of hardware and software. Although, codec 1835 is depicted as a separate component, codec 1835 can be contained within non-volatile memory 1812. By way of illustration, and not limitation, non-volatile memory 1812 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1812 can employ one or more of the disclosed memory devices, in at least some embodiments. Moreover, non-volatile memory 1812 can be computer memory (e.g., physically integrated with computer 1802 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1810 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1802 can also include removable/non-removable, volatile/non-volatile computer storage medium. FIG. 18 illustrates, for example, disk storage 1814. Disk storage 1814 includes, but is not limited to, devices like a magnetic disk drive, solid state disk (SSD), flash memory card, or memory stick. In addition, disk storage 1814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1814 to the system bus 1808, a removable or non-removable interface is typically used, such as interface 1816. It is appreciated that storage devices 1814 can store information related to a user. Such information might be stored at or provided to a server or to an application running on a user device. In one embodiment, the user can be notified (e.g., by way of output device(s) 1836) of the types of information that are stored to disk storage 1814 or transmitted to the server or application. The user can be provided the opportunity to opt-in or opt-out of having such information collected or shared with the server or application (e.g., by way of input from input device(s) 1828).

It is to be appreciated that FIG. 18 describes software that acts as an intermediary between users and the basic computer resources described in the suitable operating environment 1800. Such software includes an operating system 1818. Operating system 1818, which can be stored on disk storage 1814, acts to control and allocate resources of the computer system 1802. Applications 1820 take advantage of the management of resources by operating system 1818 through program modules 1824, and program data 1826, such as the boot/shutdown transaction table and the like, stored either in system memory 1806 or on disk storage 1814. It is to be appreciated that the claimed subject matter can be implemented with various operating systems or combinations of operating systems.

A user enters commands or information into the computer 1802 through input device(s) 1828. Input devices 1828 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1804 through the system bus 1808 via interface port(s) 1830. Interface port(s) 1830 include, for example, a serial port, a parallel port, a game port, and a universal serial bus (USB). Output device(s) 1836 use some of the same type of ports as input device(s) 1828. Thus, for example, a USB port can be used to provide input to computer 1802 and to output information from computer 1802 to an output device 1836. Output adapter 1834 is provided to illustrate that there are some output devices 1836 like monitors, speakers, and printers, among other output devices 1836, which require special adapters. The output adapters 1834 include, by way of illustration and not limitation, video and sound cards that provide a way of connection between the output device 1836 and the system bus 1808. It should be noted that other devices or systems of devices provide both input and output capabilities such as remote computer(s) 1838.

Computer 1802 can operate in a networked environment using logical connections to one or more remote computers, such as remote computer(s) 1838. The remote computer(s) 1838 can be a personal computer, a server, a router, a network PC, a workstation, a microprocessor based appliance, a peer device, a smart phone, a tablet, or other network node, and typically includes many of the elements described relative to computer 1802. For purposes of brevity, only a memory storage device 1840 is illustrated with remote computer(s) 1838. Remote computer(s) 1838 is logically connected to computer 1802 through a network interface 1842 and then connected via communication connection(s) 1844. Network interface 1842 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1844 refers to the hardware/software employed to connect the network interface 1842 to the bus 1808. While communication connection 1844 is shown for illustrative clarity inside computer 1802, it can also be external to computer 1802. The hardware/software necessary for connection to the network interface 1842 includes, for exemplary purposes only, internal and external technologies such as, modems including regular telephone grade modems, cable modems and DSL modems, ISDN adapters, and wired and wireless Ethernet cards, hubs, and routers.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other embodiments to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM).

Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

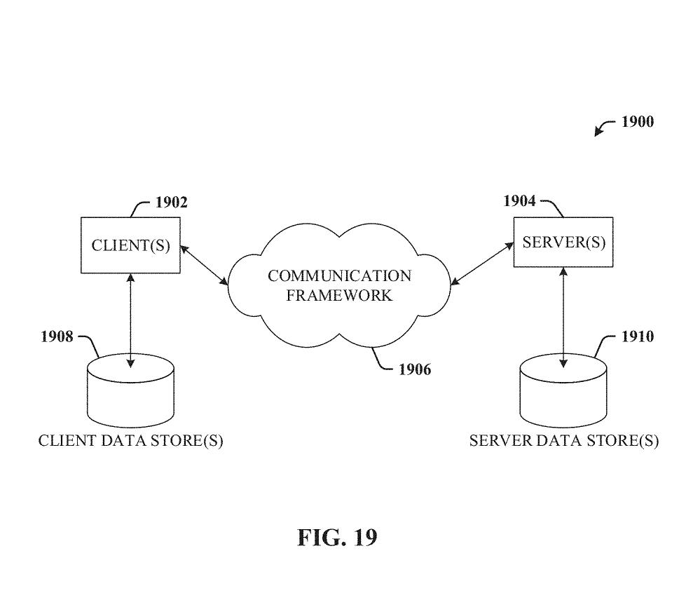

Referring now to FIG. 19, there is illustrated a schematic block diagram of an exemplary computer compilation system operable to execute the disclosed architecture. The system 1900 includes one or more client(s) 1902. The client(s) 1902 can be hardware and/or software (e.g., threads, processes, computing devices). The client(s) 1902 can house cookie(s) and/or associated contextual information by employing the claimed subject matter, for example.

The system 1900 also includes one or more server(s) 1904. The server(s) 1904 can also be hardware and/or software (e.g., threads, processes, computing devices). The servers 1904 can house threads to perform transformations by employing the claimed subject matter, for example. One possible communication between a client 1902 and a server 1904 can be in the form of a data packet adapted to be transmitted between two or more computer processes. The data packet may include a cookie and/or associated contextual information, for example. The system 1900 includes a communication framework 1906 (e.g., a global communication network such as the Internet) that can be employed to facilitate communications between the client(s) 1902 and the server(s) 1904. In some embodiments, communication framework 1906 can be representative of a cloud architecture.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other embodiments to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An incident mitigation system for a vehicle, comprising:
a memory that stores computer executable components; and
a processor that executes computer executable components stored in the memory, wherein the computer executable components comprise:
a safety component that receives activation input and, in response to the activation input, triggers an incident mitigation procedure determined to mitigate an unsafe condition for the vehicle that is in operational use; and
a protocol component that executes the incident mitigation procedure, comprising:
determining safety navigation data representative of:
a destination for the vehicle at which it is determined to be safe to terminate the operational use; and
a safe course by which to navigate the vehicle to the destination, wherein the safe course is determined to be safe.

2. The incident mitigation system of claim 1, wherein the incident mitigation procedure further comprises:
determining a type of the unsafe condition;
selecting an emergency services entity based on the type; and
transmitting notification data, representative of the unsafe condition, to a device of the emergency services entity.

3. The incident mitigation system of claim 2, wherein the notification data comprises an identification of the vehicle, a current location of the vehicle, and the destination.

4. The incident mitigation system of claim 1, wherein the incident mitigation procedure further comprises transmitting a notification of the unsafe condition to other vehicles.

5. The incident mitigation system of claim 4, wherein the other vehicles comprise vehicles determined to be in a vicinity of a current location of the vehicle, and wherein the vicinity is determined based on a defined distance from the current location.

6. The incident mitigation system of claim 5, wherein the other vehicles comprise vehicles estimated, based on a corresponding plotted navigational course, to reach the vicinity within a defined time.

7. The incident mitigation system of claim 1, wherein the incident mitigation procedure further comprises transmitting a notification of the unsafe condition to a device of a navigation service entity.

8. The incident mitigation system of claim 1, wherein the incident mitigation procedure further comprises:
determining that the vehicle is an autonomously controllable vehicle;
instructing a navigation system of the autonomously controllable vehicle to update an existing course with the safe course and;
upon arrival at the destination, instructing the autonomously controllable vehicle to disable a vehicle control system and the navigation system.

9. The incident mitigation system of claim 1, wherein the incident mitigation procedure further comprises:
determining that the vehicle is a manually-operated vehicle being operated according to an agreement with a transportation-as-a-service (TaaS) entity;
presenting to an operator of the manually-operated vehicle indicia indicating the destination and the safe course; and
transmitting a notification of the unsafe condition to a device of the TaaS entity.

10. The incident mitigation system of claim 1, further comprising an incident activation device, communicatively coupled to the safety component, that generates the activation input in response to being activated.

11. The incident mitigation system of claim 10, wherein the incident activation device is selected from a group comprising: a button or other device situated in an operator area of the vehicle, a button or other device situated in a passenger area of the vehicle, a fob device, an electronic device with a user interface (UI) that presents a button or other UI element, a sensor device that monitors an interior of the vehicle, and a sensor device that monitors an exterior of the vehicle.

12. The incident mitigation system of claim 11, the incident mitigation procedure further comprises determining a type of the unsafe condition based on a type of the incident activation device that generated the activation input.

13. An incident mitigation system for vehicles, comprising:
a memory that stores computer executable components; and
a processor that executes computer executable components stored in the memory, wherein the computer executable components comprise:
a safety component that receives activation input and, in response to the activation input, triggers an incident mitigation procedure determined to mitigate an unsafe condition for a first vehicle that is in operational use; and
a protocol component that executes the incident mitigation procedure, comprising:
determining an identification of a second vehicle representing a cause of the unsafe condition;
determining safety navigation data indicative of a safe course by which to navigate the first vehicle in response to the second vehicle; and
transmitting alert data comprising the identification of the second vehicle and the unsafe condition.

14. The incident mitigation system of claim 13, wherein the identification of the second vehicle comprises a current location of the second vehicle and the transmitting the alert data comprises transmitting the alert data to other vehicles within a defined distance of the current location.

15. The incident mitigation system of claim 14, wherein the transmitting the alert data comprises transmitting the alert data to the second vehicle.

16. The incident mitigation system of claim 15, wherein the alert data comprises an incident mitigation override command that is configured to override a current navigation course of the second vehicle according to an incident mitigation procedure.

17. A method, comprising:
receiving, by a system comprising a processor, activation input indicative of an unsafe condition for an occupant of a vehicle;
in response to the activation input, activating, by the system, an incident mitigation procedure determined to mitigate the unsafe condition, comprising:
determining, by the system, destination data representative of a destination for the vehicle at which it is determined to be safe from danger presented by the unsafe condition;
determining, by the system, course data representative of a course by which to navigate the vehicle to the destination that is determined to be safe; and
notifying, by the system, other vehicles of the unsafe condition.

18. The method of claim 17, wherein the operations further comprise determining, by the system, the other vehicles to be notified of the unsafe condition based on a defined distance from a current location of the vehicle.

19. The method of claim 17, wherein the operations further comprise determining, by the system, the other vehicles to be notified of the unsafe condition based on a determination that a current course of a second vehicle will result in the second vehicle being in a vicinity of a forecasted location of the vehicle within a defined time.

20. The method of claim 17, wherein the operations further comprise, updating, by the system, a current navigation course of the vehicle with an updated safe course according to the course data.
